(19) United States
(12) Patent Application Publication
(10) Pub. No.: US 2014/0049163 A1
(43) Pub. Date: Feb. 20, 2014

(54) ELECTRONIC DEVICE CAPABLE OF CHANGING COLOR OF CASING AND METHOD THEREOF

(71) Applicant: YUN-TIAN BAI, New Taipei City (TW)

(72) Inventor: YUN-TIAN BAI, New Taipei City (TW)

(21) Appl. No.: 13/610,878

(22) Filed: Sep. 12, 2012

(30) Foreign Application Priority Data
Aug. 14, 2012 (CN) 201210288943.X

(51) Int. Cl. H05B 37/02

(52) U.S. Cl. 315/120

(57) ABSTRACT

An electronic device capable of changing color of casing includes a casing, at least parts of the casing being made of transparent light-guiding material; a light emitting module for emitting light with N colors; a thermal sensor for sensing an environmental temperature; a storage unit for storing a look-up table, the look-up table recording N temperature ranges and the N colors, each of the N colors being corresponding to one of the N temperature ranges; and a control unit electrically connected to the light emitting module, the thermal sensor and the storage unit and used for comparing the environmental temperature with the N temperature ranges of the look-up table so as to control the light emitting module to emit light with one of the N colors.

### BACKGROUND OF THE INVENTION

1. Field of the Invention

The invention relates to an electronic device capable of changing color of a casing and a method thereof and, more particularly, to an electronic device capable of changing color of a casing according to environmental temperature and a method thereof.

2. Description of the Prior Art

As technology develops and advances, various electronic devices, such as notebook, flat computer, cell phone, personal digital assistant, and so on, have been considered necessities by a lot of people. So far most of electronic devices have one single color (e.g. black, white, silver, etc.) painted on a casing thereof and the color cannot be changed by a user. After using the electronic device for a long time, the user may feel unexciting about the color of the casing. Furthermore, though some electronic devices allow the user to change casings with different colors, it will increase use cost for the user and the casing is easy to be damaged while being changed so that the user will have no desire to purchase those electronic devices.

### SUMMARY OF THE INVENTION

The invention provides an electronic device capable of changing color of a casing and a method thereof so as to solve the aforesaid problems.

According to the claimed invention, an electronic device capable of changing color of casing comprises a casing, at least parts of the casing being made of transparent light-guiding material; a light emitting module disposed in the casing and used for emitting light with N colors, N being a positive integer larger than one; a thermal sensor disposed in the casing and used for sensing an environmental temperature; a storage unit disposed in the casing and used for storing a look-up table, the look-up table recording N temperature ranges and the N colors, each of the N colors being corresponding to one of the N temperature ranges; and a control unit electrically connected to the light emitting module, the thermal sensor and the storage unit and used for comparing the environmental temperature with the N temperature ranges of the look-up table so as to control the light emitting module to emit light with one of the N colors.

According to the claimed invention, the light emitting module comprises M light emitting units for emitting light with the N colors, M is a positive integer larger than one, and M is smaller than or equal to N.

According to the claimed invention, when M is smaller than N, light with one of the N colors is generated by mixing light emitted by at least two of the M light emitting units.

According to the claimed invention, the electronic device further comprises a trigger unit disposed on the casing and electrically connected to the control unit, wherein the trigger unit is used for triggering the control unit to control the light emitting module to emit light changed from one of the N colors to another.

According to the claimed invention, the electronic device further comprises a trigger unit disposed on the casing and electrically connected to the control unit, wherein the trigger unit is used for triggering the control unit to control the light emitting module to emit light with the N colors periodically or randomly.

According to the claimed invention, a method is capable of changing color of a casing, wherein at least parts of the casing is made of transparent light-guiding material, a light emitting module is disposed in the casing and used for emitting light with N colors, and N is a positive integer larger than one. The method comprises steps of storing a look-up table, the look-up table recording N temperature ranges and the N colors, each of the N colors being corresponding to one of the N temperature ranges; sensing an environmental temperature; and comparing the environmental temperature with the N temperature ranges of the look-up table so as to control the light emitting module to emit light with one of the N colors.

According to the claimed invention, the light emitting module comprises M light emitting units for emitting light with the N colors, M is a positive integer larger than one, and M is smaller than or equal to N.

According to the claimed invention, when M is smaller than N, the method further comprises step of controlling at least two of the M light emitting units to emit light simultaneously so as to generate light with one of the N colors.

According to the claimed invention, a trigger unit is disposed on the casing and the method further comprises step of operating the trigger unit to control the light emitting module to emit light changed from one of the N colors to another.

According to the claimed invention, a trigger unit is disposed on the casing and the method further comprises step of operating the trigger unit to control the light emitting module to emit light with the N colors periodically or randomly.

As mentioned in the above, the electronic device of the invention can control the light emitting module to emit light with different colors according to the environmental temperature sensed by the thermal sensor. Since at least parts of the casing are made of transparent light-guiding material, light emitted by the light emitting module can pass through the casing so as to be seen by the user. In other words, when the environmental temperature varies from a temperature range (e.g. 9-16° C.) to another temperature range (e.g. 17-24° C.), light emitted by the light emitting module changes form a color (e.g. yellow) to another color (e.g. green) correspondingly. Furthermore, the invention can render a warm color (e.g. orange) on the casing under low environmental temperature so as to make the user feel warm and render a cool color (e.g. blue) on the casing under high environmental temperature so as to make the user feel cool. Moreover, the user can operate the trigger unit on the casing to manually control the light emitting module to emit light changed from a color to another color or, alternatively, the user can also operate the trigger unit on the casing to manually control the light emitting module to emit light with different colors periodically or randomly. In other words, the electronic device of the invention not only can change the color of the casing automatically according to the environmental temperature but also allows the user to change the color of the casing manually according to his/her own preference.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an electronic device capable of changing color of casing according to an embodiment of the invention.

FIG. 2 is a functional block diagram illustrating the electronic device shown in FIG. 1.

FIG. 3 is a flowchart illustrating a method capable of changing color of casing according to an embodiment of the invention.

### DETAILED DESCRIPTION

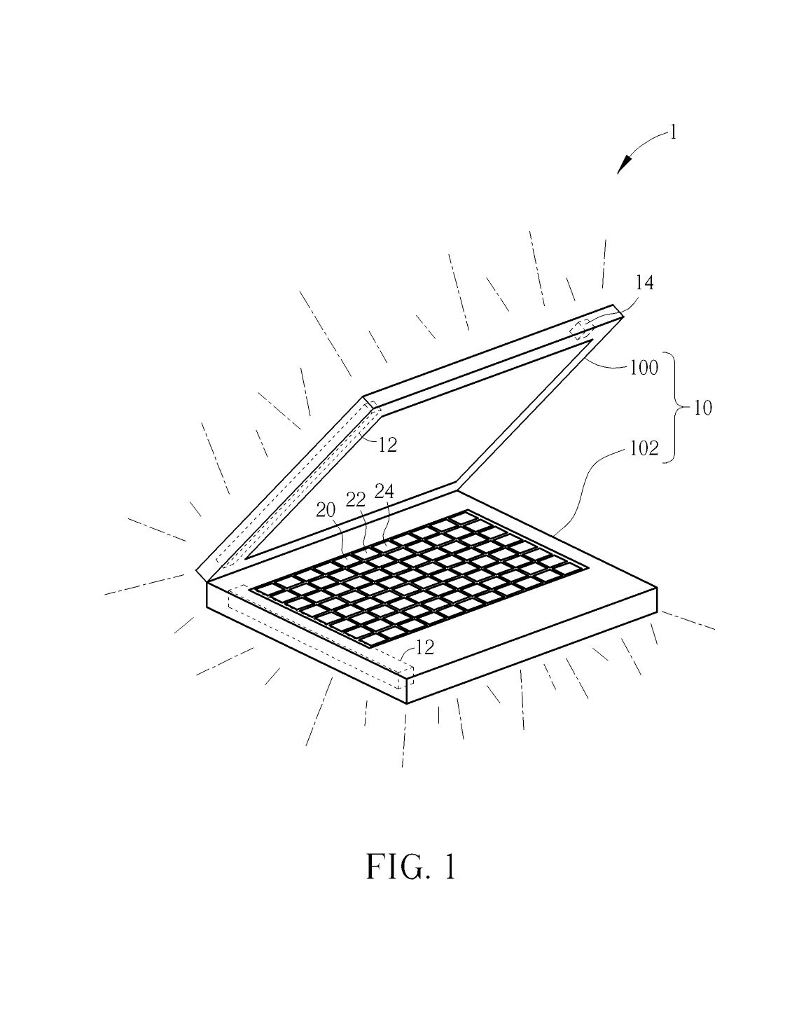

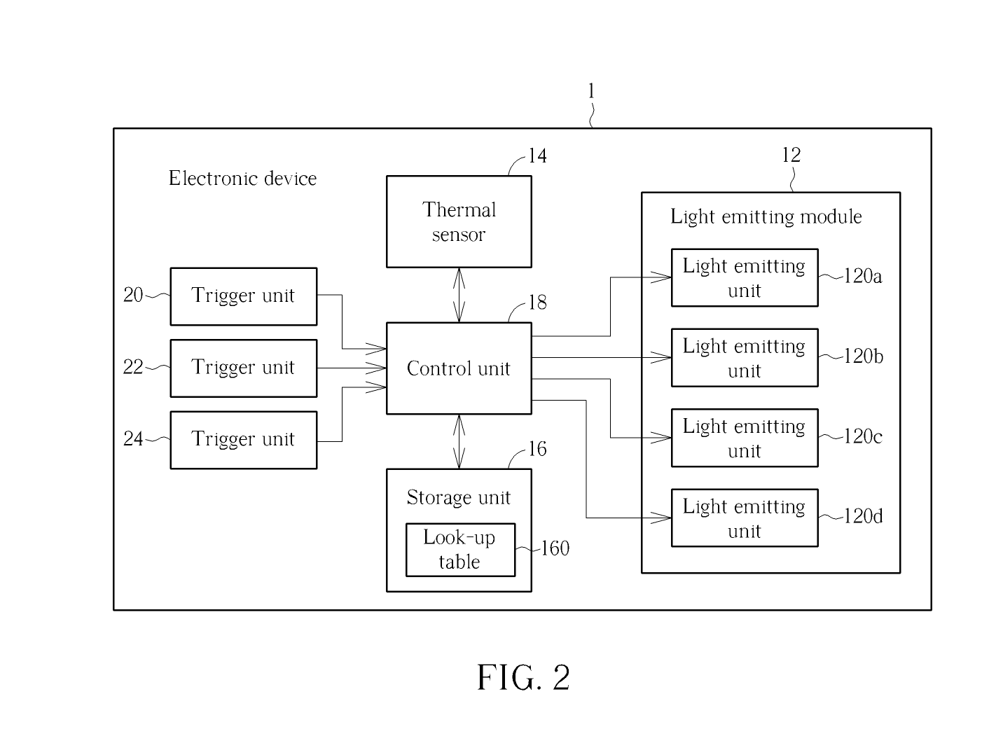

Referring to FIGS. 1 and 2, FIG. 1 is a schematic diagram illustrating an electronic device 1 capable of changing color of casing according to an embodiment of the invention, and FIG. 2 is a functional block diagram illustrating the electronic device 1 shown in FIG. 1. As shown in FIGS. 1 and 2, the electronic device 1 comprises a casing 10, a light emitting module 12, a thermal sensor 14, a storage unit 16 and a control unit 18, wherein the light emitting module 12, the thermal sensor 14, the storage unit 16 and the control unit 18 are disposed in the casing 10, and the control unit 18 is electrically connected to the light emitting module 12, the thermal sensor 14 and the storage unit 16. In this embodiment, the electronic device 1 may be, but not limited to, a notebook. In another embodiment, the electronic device 1 may be a flat computer, a cell phone, a personal digital assistant or other electronic devices.

At least parts of the casing 10 are made of, but not limited to, transparent light-guiding material, such as polymethylmethacrylate (PMMA). In this embodiment, the casing 10 may comprise an upper casing 100 and a lower casing 102, the upper casing 100 is pivotally connected to the lower casing 102, and the upper casing 100 and the lower casing 102 both are made of transparent light-guiding material. It should be noted that the invention may also make one of the upper casing 100 and the lower casing 102 by transparent light-guiding material or make parts of the upper casing 100 and the lower casing 102 by transparent light-guiding material, and it depends on practical applications.

The light emitting module 12 is used for emitting light with N colors, wherein N is a positive integer larger than one. In other words, the light emitting module 12 can emit light with at least two colors based on practical applications. In this embodiment, since the upper casing 100 and the lower casing 102 both are made of transparent light-guiding material, a plurality of light emitting modules 12 can be disposed at peripheries of the upper casing 100 and the lower casing 102. Furthermore, the light emitting module 12 comprises M light emitting units for emitting light with N colors, wherein M is a positive integer larger than one and M is smaller than or equal to N. In other words, the light emitting module 12 comprises at least two light emitting units for emitting light with at least two colors based on practical applications.

As shown in FIG. 2, the light emitting module 12 comprises four light emitting units 120a-120d for emitting light with four colors. For example, the light emitting unit 120a may emit orange light, the light emitting unit 120b may emit yellow light, the light emitting unit 120c may emit green light, and the light emitting unit 120d may emit blue light. In practical applications, each of the light emitting units 120a-120d may comprise at least one light emitting diode or other light source.

The thermal sensor 14 is used for sensing an environmental temperature at a place where the electronic device 1 is situated. In this embodiment, the thermal sensor 14 is disposed in the upper casing 100, as shown in FIG. 1. However, in another embodiment, the thermal sensor 14 may be also disposed in the lower casing 102 and it depends on practical applications. The storage unit 16 is used for storing a look-up table 160, wherein the look-up table 160 records N temperature ranges and N colors and each of the N colors is corresponding to one of the N temperature ranges. In this embodiment, the storage unit 16 may be, but not limited to, an electrically erasable programmable read only memory (EEPROM). In another embodiment, the storage unit 16 may be other non-volatile or volatile memory. For example, the look-up table 160 may record four temperature ranges and four colors correspondingly, as shown in the following table 1.

TABLE 1
Look-up table 160

| Temperature range | Color |
|---|---|
| 0-8° C. | Orange |
| 9-16° C. | Yellow |
| 17-24° C. | Green |
| 25-∞° C. | Blue |

After the thermal sensor 14 senses the environmental temperature at the place where the electronic device 1 is situated, the thermal sensor 14 converts the environmental temperature from analog signal to digital signal and then transmits the environmental temperature to the control unit 18. Then, the control unit 18 compares the environmental temperature with the four temperature ranges of the look-up table 160 so as to control the four light emitting units 120a-120d of the light emitting module 12 to emit light with one of the four colors. For example, if the environmental temperature sensed by the thermal sensor 14 is 10° C., the control unit 18 controls the light emitting unit 120b of the light emitting module 12 to emit yellow light; if the environmental temperature sensed by the thermal sensor 14 is 20° C., the control unit 18 controls the light emitting unit 120c of the light emitting module 12 to emit green light; and so on.

Since at least parts of the casing 10 are made of transparent light-guiding material, light emitted by the light emitting module 12 can pass through the casing 10 so as to be seen by the user. In other words, when the environmental temperature varies from a temperature range (e.g. 9-16° C.) to another temperature range (e.g. 17-24° C.), light emitted by the light emitting module 12 changes form a color (e.g. yellow) to another color (e.g. green) correspondingly. Furthermore, the invention can render a warm color (e.g. orange) on the casing 10 under low environmental temperature (e.g. temperature in winter lower than 8° C.) so as to make the user feel warm and render a cool color (e.g. blue) on the casing under high environmental temperature (e.g. temperature in summer higher than 25° C.) so as to make the user feel cool.

It should be noted that if at least two of the four light emitting units 120a-120d emit light simultaneously, light with other mixed color can be generated accordingly. In other words, the invention can utilize four light emitting units 120a-120d to emit light with more than four colors so as to increase color variation of the casing 10.

Still further, as shown in FIGS. 1 and 2, the electronic device 1 may further comprise three trigger units 20, 22, 24 disposed on the lower casing 102 of the casing 10 and electrically connected to the control unit 18. In this embodiment, the trigger units 20, 22, 24 may be, but not limited to, buttons. The user can operate the trigger unit 20 (e.g. press the trigger unit 20) to trigger the control unit 18 to control the light emitting module 12 to emit light changed from one of the four colors to another. At this time, the color of light emitted by the light emitting module 12 will not change no matter how the environmental temperature varies. For example, when the user presses the trigger unit 20 once, light emitted by the light emitting module 12 will change from orange to yellow; when the user presses the trigger unit 20 once again, light emitted by the light emitting module 12 will change from yellow to green; and so on.

Under manual mode, the user may also operate the trigger unit 22 (e.g. press the trigger unit 22) to trigger the control unit 18 to control the light emitting module 12 to emit light with the four colors periodically. For example, when the user presses the trigger unit 22, the control unit 18 will control the light emitting module 12 to change the color of light every a predetermined time period (e.g. three seconds, five seconds, etc.) sequentially so that the color of the casing 10 will vary regularly.

Under manual mode, the user may also operate the trigger unit 24 (e.g. press the trigger unit 24) to trigger the control unit 18 to control the light emitting module 12 to emit light with the four colors randomly. For example, when the user presses the trigger unit 24, the control unit 18 will control the light emitting module 12 to change the color of light every a predetermined time period (e.g. three seconds, five seconds, etc.) randomly so that the color of the casing 10 will vary irregularly.

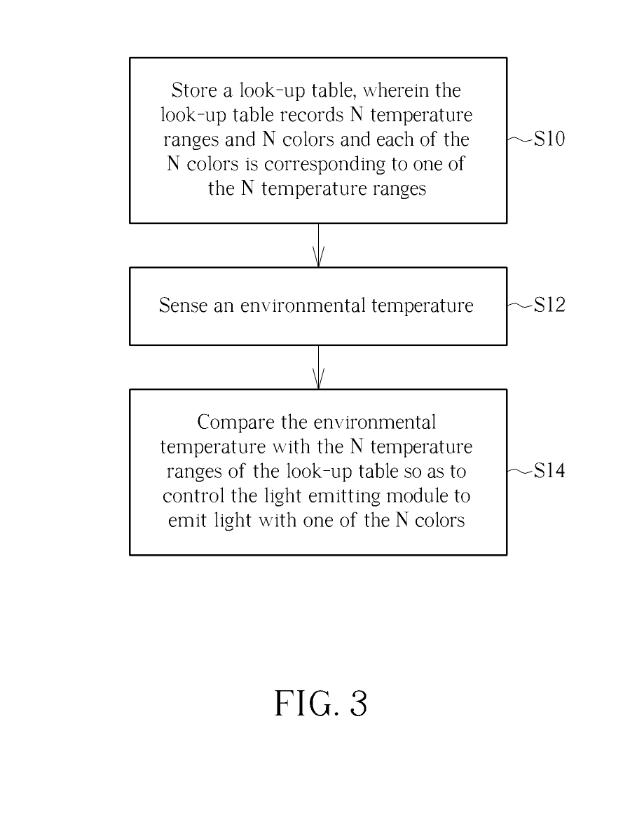

Referring to FIG. 3, FIG. 3 is a flowchart illustrating a method capable of changing color of casing according to an embodiment of the invention. The method shown in FIG. 3 can be implemented by the electronic device 1 shown in FIGS. 1 and 2. First of all, step S10 is performed to store a look-up table 160, wherein the look-up table 160 records N temperature ranges and N colors and each of the N colors is corresponding to one of the N temperature ranges. Afterward, step S12 is performed to sense an environmental temperature at a place where the electronic device 1 is situated. Then, step S14 is performed to compare the environmental temperature with the N temperature ranges of the look-up table 160 so as to control the light emitting module 12 to emit light with one of the N colors. Since at least parts of the casing 10 are made of transparent light-guiding material, light emitted by the light emitting module 12 can pass through the casing 10 so as to be seen by the user . The method of the invention may control at least two light emitting units 120a-120d to emit light simultaneously so as to generate light with other mixed color. Furthermore, under manual mode, the trigger unit 20 can be operated to change the color of light emitted by the light emitting module 12 from one of the N colors to another. Moreover, under manual mode, the trigger units 22, 24 can be operated to control the light emitting module 12 to emit light with the N colors periodically or randomly. It should be noted that the detailed operation and principle have been mentioned in the above and will not be depicted herein again.

Furthermore, the control logics of the method shown in FIG. 3 can be implemented by software. It is reasonably expected that each part or function of the control logics may be implemented by software, hardware or the combination thereof. Moreover, the control logics can be embodied by a computer readable storage medium, wherein the computer readable storage medium stores instructions, which can be executed by the electronic device 1 so as to generate control command for controlling the electronic device 1 to execute corresponding function.

As mentioned in the above, the electronic device of the invention can control the light emitting module to emit light with different colors according to the environmental temperature sensed by the thermal sensor. Since at least parts of the casing are made of transparent light-guiding material, light emitted by the light emitting module can pass through the casing so as to be seen by the user. In other words, when the environmental temperature varies from a temperature range (e.g. 9-16° C.) to another temperature range (e.g. 17-24° C.), light emitted by the light emitting module changes form a color (e.g. yellow) to another color (e.g. green) correspondingly. Furthermore, the invention can render a warm color (e.g. orange) on the casing under low environmental temperature so as to make the user feel warm and render a cool color (e.g. blue) on the casing under high environmental temperature so as to make the user feel cool. Moreover, the user can operate the trigger unit on the casing to manually control the light emitting module to emit light changed from a color to another color or, alternatively, the user can also operate the trigger unit on the casing to manually control the light emitting module to emit light with different colors periodically or randomly. In other words, the electronic device of the invention not only can change the color of the casing automatically according to the environmental temperature but also allows the user to change the color of the casing manually according to his/her own preference.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device capable of changing color of casing comprising:
a casing, at least parts of the casing being made of transparent light-guiding material;
a light emitting module disposed in the casing and used for emitting light with N colors, N being a positive integer larger than one;
a thermal sensor disposed in the casing and used for sensing an environmental temperature;
a storage unit disposed in the casing and used for storing a look-up table, the look-up table recording N temperature ranges and the N colors, each of the N colors being corresponding to one of the N temperature ranges; and
a control unit electrically connected to the light emitting module, the thermal sensor and the storage unit and used for comparing the environmental temperature with the N temperature ranges of the look-up table so as to control the light emitting module to emit light with one of the N colors.

2. The electronic device of claim 1, wherein the light emitting module comprises M light emitting units for emitting light with the N colors, M is a positive integer larger than one, and M is smaller than or equal to N.

3. The electronic device of claim 2, wherein when M is smaller than N, light with one of the N colors is generated by mixing light emitted by at least two of the M light emitting units.

4. The electronic device of claim 1, further comprising a trigger unit disposed on the casing and electrically connected to the control unit, wherein the trigger unit is used for triggering the control unit to control the light emitting module to emit light changed from one of the N colors to another.

5. The electronic device of claim 1, further comprising a trigger unit disposed on the casing and electrically connected to the control unit, wherein the trigger unit is used for triggering the control unit to control the light emitting module to emit light with the N colors periodically or randomly.

6. A method capable of changing color of a casing, at least parts of the casing being made of transparent light-guiding material, a light emitting module being disposed in the casing and used for emitting light with N colors, N being a positive integer larger than one, the method comprising:
storing a look-up table, the look-up table recording N temperature ranges and the N colors, each of the N colors being corresponding to one of the N temperature ranges;
sensing an environmental temperature; and
comparing the environmental temperature with the N temperature ranges of the look-up table so as to control the light emitting module to emit light with one of the N colors.

7. The method of claim 6, wherein the light emitting module comprises M light emitting units for emitting light with the N colors, M is a positive integer larger than one, and M is smaller than or equal to N.

8. The method of claim 7, wherein when M is smaller than N, the method further comprises:
controlling at least two of the M light emitting units to emit light simultaneously so as to generate light with one of the N colors.

9. The method of claim 6, wherein a trigger unit is disposed on the casing and the method further comprises:
operating the trigger unit to control the light emitting module to emit light changed from one of the N colors to another.

10. The method of claim 6, wherein a trigger unit is disposed on the casing and the method further comprises:
operating the trigger unit to control the light emitting module to emit light with the N colors periodically or randomly.
